(19) United States
(12) Patent Application Publication
(10) Pub. No.: US 2015/0186754 A1
(43) Pub. Date: Jul. 2, 2015

(54) CLASSIFICATION METHOD FOR SPECTRAL DATA

(71) Applicant: Nederlandse Organisatie voor toegepast- natuurwetenschappelijk onderzoek TNO, Delft (NL)

(72) Inventor: Armand Paauw, Delft (NL)

(21) Appl. No.: 14/414,990

(22) PCT Filed: Jul. 18, 2013
(86) PCT No.: PCT/NL2013/050544

§ 371 Date: Jan. 15, 2015

(30) Foreign Application Priority Data
Jul. 18, 2012 (EP) 12176908.7

(51) Int. Cl. G06K 9/62

(52) U.S. Cl. CPC G06K 9/6267

(57) ABSTRACT

The present invention relates to a new method for classification of spectral data comprising:
a. obtaining at least two spectrograms of different mass range of a sample by performing at least two different mass spectrography measurements, each with a different matrix;
b. adding the at least two spectrograms;
c. comparing the sample spectrogram resulting from step b) with one or more spectrograms of known samples;
d. if there is no difference between the sample spectrogram and a spectrogram of a known sample, declaring the sample identical to the known sample.

### THE INVENTION

The present invention relates to methods for classification, more specifically for classification of data derived from spectrographic analyses, more specifically mass spectrography methods that make use of a matrix, such as MALDI, Raman spectrometry, and the like, in order to classify an unknown sample on basis of the spectral information.

### BACKGROUND

Nowadays, spectrographic methods are frequently used to analyse biomaterials. Whereas initially spectrometry was most heavily used in the fields of chemistry, and for the detection of (single) reaction compounds, it has increasingly become used in the biosciences for the analysis of biological samples.

Spectrometry is also used for the analysis of complete organisms, such as bacteria and viruses. In such a case, it is not so much of importance which exact individual chemical compounds are reflected in the spectrum, but the goal of this analysis is much more to identify and classify the microorganism(s) in the sample. It has been recognized in the meantime that different microorganisms yield markedly different spectral data (irrespective whether the measurement is through a mass spectrometry, such as MALDI, Raman spectrometry, infrared spectrometry, or any other spectrometrical method). Many applications have hitherto been proposed for measuring and classifying microorganisms using spectral data (e.g. WO 2010/062354, WO 2010/062351, WO 2007/056568, CN 2009/1202963, WO 2005/060380, US 2004/234952, WO 2004/015136, WO 01/79523, JP 2028772). Every microorganism strain produces a spectrum that can be regarded as a fingerprint pattern with specific signals at strain, species, genera and family level. These specific signals can be used for automated identification of unknown strains. Requirements for modern methods suitable for microorganism identification and characterization are robustness, simple handling, low costs, speed and high-throughput capability. Therefore, spectrometry techniques, such as mass spectrometry may offer significant advantages over classical technologies e.g., polymerase chain reaction, sequencing, electrophoretic separation of nucleic acid fragments.

For the interpretation of these complex spectra additional aids need to be developed. Some existing methods for analysis include pattern recognition techniques and visual interpretation of spectra. Many techniques use some form of statistical analysis, such as principal component analysis, and similar multivariate analysis methods. In these analyses it can be the goal to analyse whether or not a known substance is present in the sample—as is the case in the detection of biomolecules such as proteins or polysaccharides in a sample—but it can also be used to monitor biological processes.

In biological samples in most cases many components, each giving their own spectral peaks, are contained within the sample.

Several commercial systems for identification of microorganisms on basis of MALDI TOF mass spectrometry are available nowadays. One example is the system from AnagnosTec under the trade name SARAMIS™. In this system a number of reference spectra (so-called SuperSpectra™) is provided against which a sample spectrum is compared and as result of that comparison the sample spectrum (and thus the microorganism) is assigned to the cluster which is represented by this spectrum. An improvement to this system has been described in co-pending application WO 2012/044170, which is herein incorporated by reference.

Another example is the MALDI Biotyper™ system from Bruker Daltronics, which also makes use of a similar reference library of more than 3500 micro-organisms, representing more than 2000 different species. It has been proven to be a robust system with a high inter-laboratory reproducibility (Mellmann et al., 2009, J. Clin. Microbiol. 47:3732-3734)

These systems are based on the fact that a micro-organism contains a diversity of components that give a characteristic peak. However, this also forms a problem in the sense that the matrix that is used for performing the spectrometry usually limits the analysis to a particular type of components (proteins, or nucleic acids, or lipids, etc.), to a particular mass range of such components and/or to a particular resolution. Due to this limited mass range or limited resolution the full spectrum of available information from the components that are present in the sample is not used. Thus there is still need for an improved method for classifying complex biological samples with spectrometric methods.

### SUMMARY OF THE INVENTION

The present inventors now have devised a method that is able to overcome the above-mentioned difficulties. Therefore, the invention comprises a method for classification of spectral data by:
a. obtaining at least two spectrograms of different mass range of a sample by performing at least two different mass spectrography measurements, each with a different matrix;
b. adding the at least two spectrograms;
c. comparing the sample spectrogram resulting from step b) with one or more spectrograms of known samples;
d. if there is no difference between the sample spectrogram and a spectrogram of a known sample, declaring the sample identical to the known sample.

Preferably, in said method the matrices are selected from the group of matrices listed in Table 1.

In a further preferred embodiment the sample comprises a micro-organism, preferably a bacterium, a virus or a fungus.

The invention is especially suitable for spectrograms obtained with the MALDI-TOF method.

In a further embodiment, the two or more spectrograms may be partially overlapping.

Also part of the invention is the use of a spectrogram which is composed of at least two spectrograms obtained by analysing a sample in a mass spectrometer with at least two different matrices, for the classification of spectral data, particularly spectral data of micro-organisms.

Further part of the invention is a method for classification of micro-organisms comprising:
a. obtaining at least two spectrograms of different mass range of a sample of said micro-organism by performing at least two different mass spectrography measurements, each with a different matrix;
b. adding the at least two spectrograms obtained in step a);
c. comparing the resulting spectrogram resulting from step b) with one or more spectrograms of samples of known micro-organisms;
d. if there is no difference between the spectrogram obtained in step b) and a spectrogram of a known micro-organism, declaring the micro-organism to be classified identical to the known micro-organism.

Preferably, in such a method the known micro-organism is a particular strain of a micro-organism species of which the spectrogram differs from the spectrogram of a different strain of the same micro-organism species.

### DESCRIPTION OF THE FIGURES

FIG. 1 General overview of the invention. By generating spectra from (parts of) the same sample but with different matrices or with different settings and by combining these spectra to one total spectrum the spectral information that can be derived from a sample is increased.

FIG. 2 shows an example of three spectra obtained from Shigella flexneri with two different matrices, α-cyano-4-hydroxycinnamic acid (HCCA) and ferulic acid (FA). Samples with HCCA matrix where measured in a linear and reflectron mode. The sample with the FA matrix was measured in the linear mode. In the Table at the bottom right it is indicated which size ranges are covered by the three matrices. Further it follows from this Table that the extent of information is not only caused by an increase in the size range that is now covered, but it also appears that in the size range in which two matrices form an overlap different spectral peaks have become visible, thereby also increasing the spectral information density in the overlapping region.

### DETAILED DESCRIPTION

The present invention offers a solution for the problem that sometimes the resolution of a spectral analysis is too low to provide a meaningful difference between spectra of one species versus spectra of another species, which would lead to an imprecise classification capacity. Especially in the case of species which strongly resemble each other, or for closely related strains within one and the same species, the differences can be so small in a given spectrum that no meaningful classification can be obtained. It is, however, rather difficult, if not impossible, to increase the resolution of a spectrum by generating intermediate data points.

The resolution in normal MALDI-TOF applications is largely dependent from the type of MALDI system used (such as TOF or reflection-TOF), the type of laser used (e.g. UV or IR) and the type of the matrix used, where there are several possible matrices depending on the kind of molecule that is needed to be analyzed. In general MALDI matrices must need a number of requirements:
they should be able to embed and isolate analytes (e.g. by co-crystallization)
they should be solvable in a solvent that is compatible with the analyte
they should be stable in vacuum
they should absorb the laser wavelength
they should cause co-desorption of the analyte upon laser irradiation
they should promote analyte ionization.

It is believed that compounds with labile protons, such as carboxylic acids, form good MALDI matrices because they are easily able to protonate neutral analyte molecules. Because it is general found that use of acidic solvents is disadvantageous because such an acidic solvent would cause denaturation of the analyte, for protein measurements mostly nonacidic matrices are used (M. Fitzgerald, et al., 1993, Anal. Chem. 65:3204-3211).

Compounds that are not easily protonated can be cationized instead, often by adding a small amount of salt (alkali cations, Cu or Ag) to the sample. It is also possible to detect analytes as radical cations by employing so-called electron transfer matrices (T. McCarley et al., 1998, Anal. Chem. 70:4376-4379).

The choice of the matrix is often imposed by the nature of the analyte, since some matrices are incompatible with some analytes.

Solutions for increasing the resolution of spectrographic data have been proposed in e.g. US 2001/014461, WO 2006/029838 and in Gonnet F. et al., 2003, Proteome Science 1:2. There, it has been proposed to measure the same sample in a spectrography method using two different matrices to increase the performance in the identification of compounds of the sample. However, in said documents no relation with the size of the components is discussed. It has further been established that a matrix is optimally suited for the analysis of analyte components only in a given molecular weight range. For instance, oligonucleotides having a molecular mass of less than 3.5 kDa are best detected in a matrix of 2,4,6-triacetophenone, while larger nucleic acids may appropriately be analyzed in a matrix of nicotinic acid, 3-hydryxypicolinic acid or anthranilic acid.

However, in the case of analysis of micro-organisms, a sheer multitude of molecules of all kinds of molecular species will be available in the sample and by analyzing such a micro-organism in a MALDI mass spectrographic method wherein only a single matrix is employed the variety in the sample is not fully used.

This is solved by making a two or more samples of the analyte with different matrices.

First of all, as has been described in the above-cited documents, even for the same class of compounds, use of another matrix can have a beneficial effect, since the specific properties of the matrix often determine not only the size range and the species of components that can be analyzed, but also the nature of the effect of the laser irradiation and the possible elements that are freed from the analyte.

Thus, by using spectral analysis methods with at least two different matrices that cover a different mass range two or more different spectra of the same biological sample can be obtained.

In a next step of the method the information of these two or more spectra of the same biological sample is combined. This is easily done since the spectra will be generated with the same spectral analysing apparatus and the values of the spectra are arranged by mass. Accordingly, after normalization it is just a matter of combining the two or more spectra together. Combining in this respect means any method to add the information from one spectrum to a second spectrum. Combining thus, preferably can be done by adding the two or more spectra together, but also other processes, such as averaging, would be possible. If the spectra are dealing with overlapping mass ranges, the combining of two or more spectra in the same mass region can be considered as an increase in the resolution, since for the same mass area now more data points will be available. If the spectral data relate to different mass ranges, it can be considered as an increase in spectrographic data points that are obtained from the same sample. In both cases, it will be clear that the information density, and with that the discriminative power, of a combination of two spectra for the same sample is at least double of that of a single spectrum.

In the statistical analysis no major adaptations need to be introduced to deal with this increase in spectrographic data. The same kind of pattern recognition statistical analyses that are currently used in commercial systems and of which an improvement has been described in WO 2012/044170 can be used.

In order to obtain two or more spectra of the same biological sample but with different matrices, advantageously a platform, such as a microtiter plate is used in which in different wells the matrix solutions are pre-introduced. Then for each different matrix solution an aliquot of the same biological sample will be added. The sample and the matrices may also be applied in the reverse order.

Suitable matrices can be selected from the following table, in which the species of molecules for which they are advantageously suited is indicated. In many cases also an indication is given for the mass range that can be analysed with a specific matrix.

TABLE 1
Matrices that are suitable for spectrographic analysis

| | Laser type or | | Mass | |
|---|---|---|---|---|
| Compound | solution type | Suited for | range | |
| α-cyano-4-hydroxycinnamic acid | | peptide/protein | <10 | kDa |
| (CHCA, HCCA) | | carbohydrate | | |
| sinapic acid (SA) | | peptide/protein | >10 | kDa |
| | | dendrimers | | |
| | | fullerenes | | |
| 2-(4-hydroxyphenylazo)benzoic | | peptide/protein | >10 | kDa |
| acid (HABA) | | | | |
| succinic acid | IR | peptide/protein | | |
| | | synthetic polymer | | |
| 2-5-dihydrobenzoic acid | polar | peptide/protein | | |
| 2-6-dihydroacetophenone | UV | peptide/protein | | |
| ferulic acid | UV | peptide/protein | | |
| caffeic acid | UV | peptide/protein | | |
| glycerol | liquid matrix | peptide/protein | | |
| 4-nitroaniline | liquid matrix | peptide/protein | | |
| 2,4,6-trihydroxyacetophenone | acidic | oligonucleotide | <3.5 | kDa |
| (THAP) | | carbohydrate | | |
| picolinic acid (PA) | | oligonucleotide | | |
| 3-hydroxypinolinic acid (HPA) | | oligonucleotide | >3.5 | kDa |
| anthranilic acid | | oligonucleotide | >3.5 | kDa |
| nicotinic acid | | oligonucleotide | >3.5 | kDa |
| salicylamide | | oligonucleotide | >3.5 | kDa |
| trans-3-indoleacrylic acid (IAA) | non-polar | synthetic polymer | | |
| dithranol (DIT) | non-polar | synthetic polymer | | |
| | | lipid | | |
| | | dendrimer | | |
| 1,5-diaminonaphthalene (DAN) | | gangliosides | | |
| | | peptide/protein | | |
| isovanillin | | organic molecule | | |
| 1-isoquinolinol | | oligosaccharide | | |
| T-2-(3-(4-t-Butyl-phenyl)-2- | | inorganic | | |
| methyl-2- | | molecule | | |
| propenylidene)malononitrile | | | | |
| 2-mercaptobenzothiazole (MBT) | | peptides | small | |
| chloro-cyano-cinnamic acid | | phospholipids | | |
| (CICCA) | | | | |
| fluoro-cyano-cinnamic acid | | phospholipids | | |
| (FCCA) | | | | |
| N-isopropyl-N-methyl-N-tert- | liquid matrix | peptide/protein | 0.5-300 | kDa |
| butylammonium α-cyano-4- | | | | |
| hydroxycinnamate [IMTBA | | | | |
| CHCA] | | | | |
| N,N-diisopropylethylammonium | liquid matrix | peptide/protein | 0.5-300 | kDa |
| α-cyano-4-hydroxycinnamate | | | | |
| [DIEA CHCA] | | | | |
| A-di(2-aminopentane) α-cyano-4- | liquid matrix | peptide/protein | 0.5-300 | kDa |
| hydroxycinnamate [di(AP) CHCA] | | | | |
| N-isopropyl-N-methyl- | liquid matrix | peptide/protein | 0.5-300 | kDa |
| N-tert-butylammonium ferulate | | | | |
| [IMTBA FA] | | | | |
| diisopropylethylammonium ferulate | liquid matrix | peptide/protein | 0.5-300 | kDa |
| [DIEA FA] | | | | |
| di(2-aminopentane) ferulate | liquid matrix | peptide/protein | 0.5-300 | kDa |
| [di(AP) FA] | | | | |

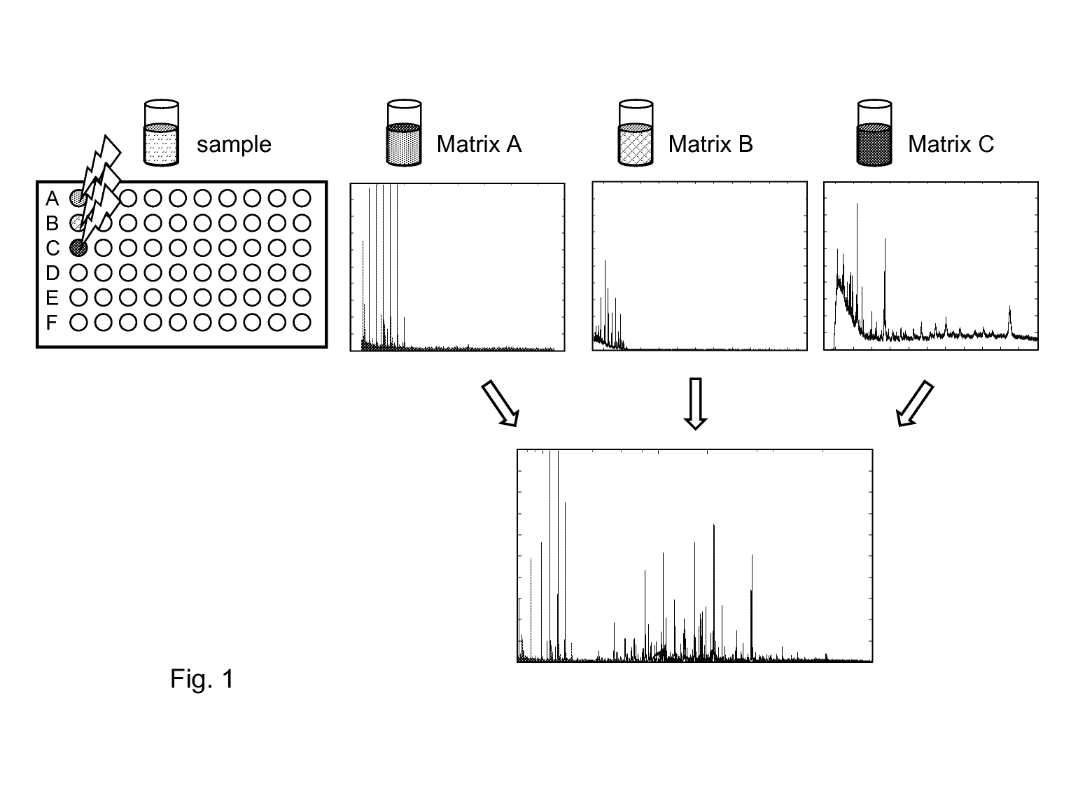

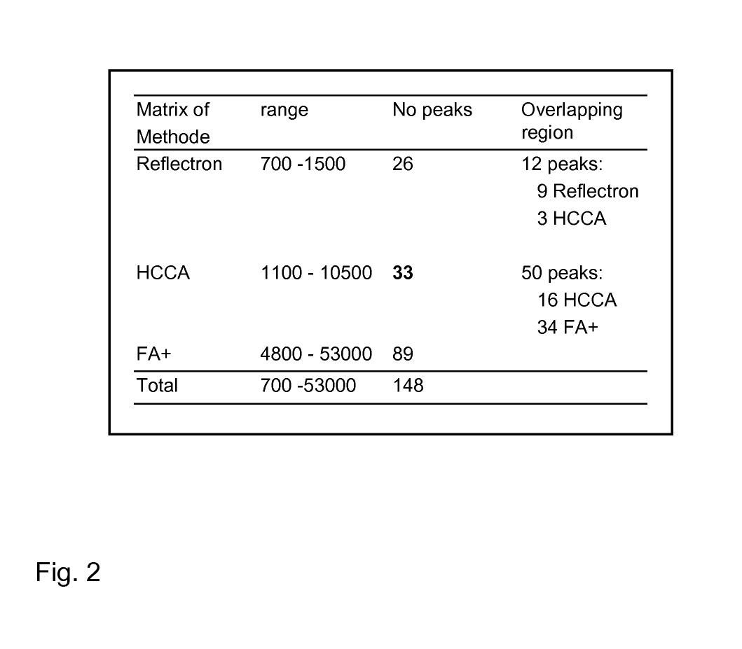

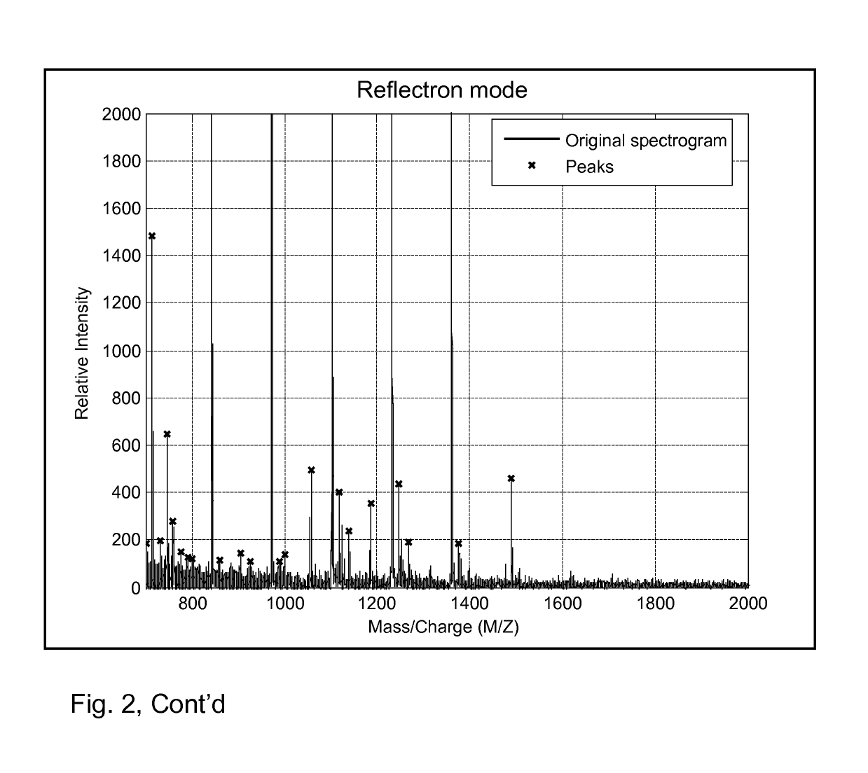

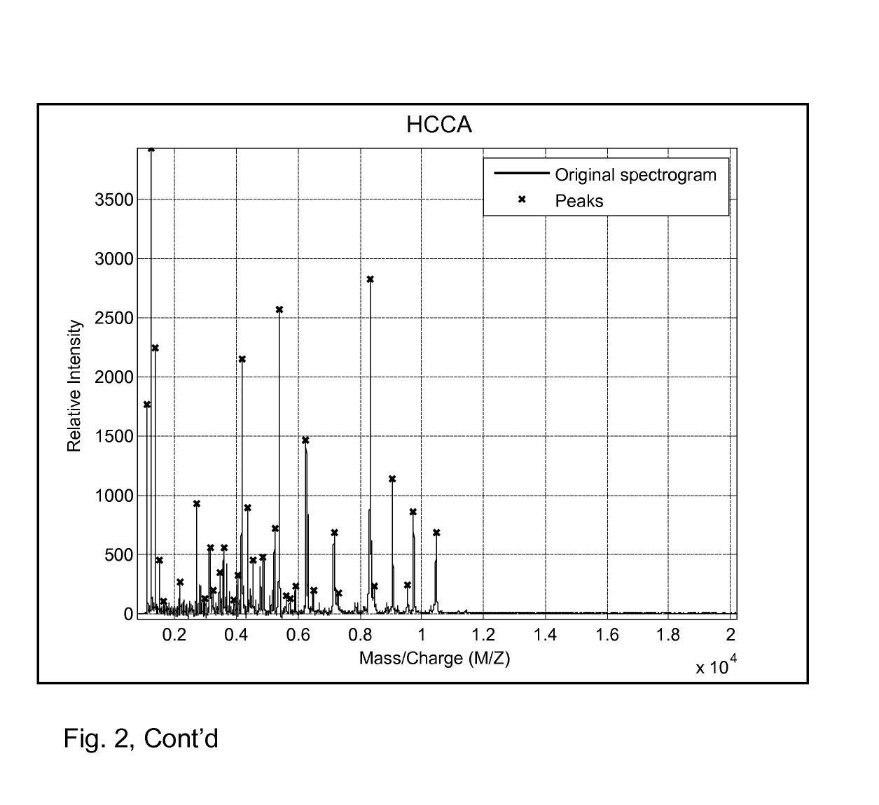

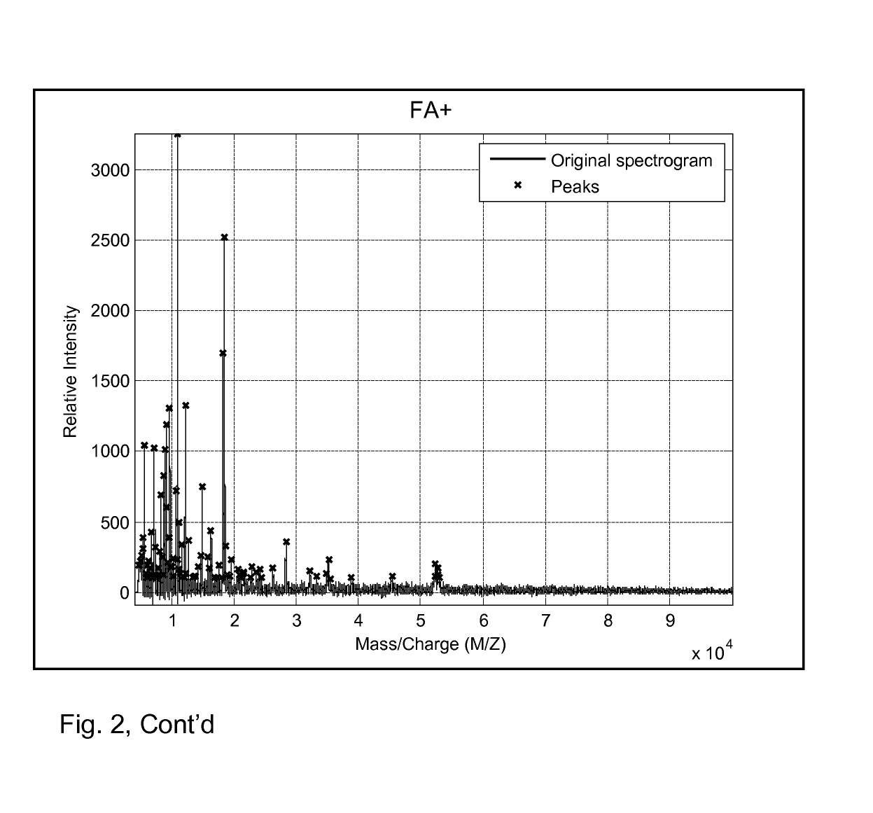

The recording of the spectrum can be achieved by any instrument that is suited for such a measurement and which instrument is able to use a matrix for presenting the sample, such as a mass spectrometer. It is preferred, as is indicated in FIG. 1, to superimpose the individual spectra of one and the same sample, forming an ‘extended spectrum’ with all the information from the underlying spectral measurements. Such a joined extended spectrum can be compared with a similarly constructed joint extended spectrum from another sample, or one that has been stored in a reference library.

When a reference library is made for classification purposes, it is not necessary that it contains extended spectra that have been made with measurements based on the same matrices as will be used when analysing an unknown sample for comparison with the reference library. Since the spectrum is based on the mass of the ionized molecule that delivers the signal, the same molecule will give a similar signal even if it is processed in the spectrometer with another matrix. Accordingly, even if a spectrum is obtained with another matrix, it can still function as a reference spectrum, although the match between the sample and the reference will not be as perfect as when the sample has been performed with the same matrix as the reference. This same principle of course applies when the spectrum is a spectrum that has been made by adding separate spectra.

The processing means for analysing the spectrum and/or comparing it with a reference spectrum, which will typically be a computer which, in operation, executes a computer program, is also part of the present invention. The computer may be a personal computer, or any other type of processing device, such as a single processor or multiprocessor system. The program may be stored in a storage medium, such as, e.g., a floppy disk or CD-ROM which is read by a medium drive device such as, e.g., a floppy disk drive or a CD ROM drive. Alternatively, the program is stored in a storage medium forming part of the computer, such as e.g., a hard disk or other memory devices.

The computer program in operation executes computer executable software code for analysis of the signal obtained from the spectrometer and for classification of the microorganism according to the analysis method and/or classification method as described herein.

The process of classification starts with taking the spectrum of an unknown sample. When the new spectrum of a sample is classified within a cluster of spectra that are already known (i.e. they are held in an accessible database), by virtue of spectroscopic similarity between the new spectrum and the cluster of spectra already in the database, said new spectrum is assumed to be part of said cluster of spectra. In such a case a cluster may contain only one or a multitude of spectra. This identity to a cluster is then used to look up in an information database (which can form part of the spectral database or may be a completely separate database) the available information about that cluster, which is then presented to the user. The information database contains information about the clusters of which spectra are present in the spectral database, which information in the case of microorganisms can be, e.g. taxonomical classification, antimicrobial agent susceptibility, virulence, known complications, etc.

If a new spectrum can not be classified unequivocally it is classified as an unknown cluster. This cluster receives a unique code-name, and the user is prompted, e.g. visually and/or audible and/or by an electronic message, to enter available information about this sample into the information database. This information may comprise e.g. the results of other techniques for identification, which in case of microorganisms may be phenotypic or genotypic and at any taxonomic level, an antibiogram, date of isolation, (patient) material from which the microorganism was isolated, and clinical complications caused by the infection. At all times it is possible for the user to update the information database when new information about a cluster becomes available, from whatever source. This may include information obtained by electronically linking and comparing information databases at regular intervals. If the new spectrum is identified as belonging to a cluster which relates to microbial strain Q, all information about strain Q, which is stored in the information database becomes available and information about the sample from which the new spectrum was obtained is added to the information database.

Preferably, all new spectra are immediately added to the cluster of spectra which results from the classification. In this way, they are immediately available to aid in identification of subsequent new samples.

The dataset of spectra available to serve as reference for newly measured spectra may continually and automatically be expanded with another measured spectrum. It is noted that the above embodiment for automated generation and automated updating of a database and its use in analyzing new spectra, is given only by way of example. It will be clear to those skilled in the art that choices for criteria that are applied and signal analysis methods that are used, can be replaced by alternatives.

The spectral database of the method of the invention thus comprises spectra from the spectrometer which have been classified into clusters according to known or new classification models. The database is automatically adapted or extended by the incorporation of new spectra. It may comprise microbial spectra of subspecies specificity. These spectra may be obtained by using one and the same matrix for mass spectroscopy or the may be obtained by using different matrices. Further, the reference spectra may provide data for only a part of the mass scale, or for a larger part of the mass scale.

The spectral database preferably comprises, next to the spectral data, information on the spectrum, such as time and date of recording, sample identification, spectrum identification, spectrometric parameters used in the recording of the spectrum (such as filters, light/energy source and the like) and/or operator identification.

More information about the spectra in the spectral database may be obtained from the information database, which is part of the spectral database or to which the spectral database may optionally be connected.

Connections between the first spectral database and other databases may be established by any means of data transfer and suitable data-transfer protocols, including but not limited to wireless data transfer, intranet systems, internet, the use of portable data storage devices such as computer diskettes and compact disks. The information database according to the invention comprises specific information on the cluster and/or each individual sample therein, comprising but not limited to sample identification, spectrum identification, time and date of sampling, peculiarities of the sample, such as addition of buffers, any pre-recording treatment of the sample (such as washing, filtering, etc.). If the sample contains biological material, the source and nature of the biological material may be part of the additional information. When the sample is a microorganism, the information database may contain information on prevalence, virulence, clinical complications, antimicrobial agent susceptibility, which data becomes instantly available. Moreover such information may be updated with the sample and/or patient information of the new sample of which the spectrum was obtained. Such information includes, but is not limited to, the time and date the patient material was obtained, the type of patient material used, the clinical condition of the patient and or the changes in the clinical condition of the patient, treatments, including the treatment for the infection and the effect thereof, diagnostic procedures that the patient has undergone, whether or not the infection has manifested itself after the patient was admitted to a hospital, antimicrobial agent susceptibility profile of the microbial strain, whether the microbial strain is or has been involved in an outbreak, virulence of the microbial strain, whether the isolated microbial strain is locally endemic (pointing to persistent source(s) of contamination), wards and departments where a patient has stayed or has been examined, taxonomic classification by other methods (including classification at genus, species and/or sub-species level), such as for instance 16S RNA sequencing Multi Locus Variable tandem repeat Analysis (MLVA), Multi Locus Sequence Typing (MLST) and other methods. In this way, the invention allows for sub-species level specific information to be obtained from a microbial strain. It also provides rapid access to useful clinical data such as best course of treatment, known complications of an infection with the particular strain and e.g. virulence of the microorganism. At the same time it provides information regarding earlier cases of infection with the same microorganism. This allows for the rapid determination of a source from which the microorganism is spread, such as for instance a non sterile medical device, which requires additional measures to be taken, or a foodstuff.

In another preferred embodiment, the spectral database or algorithm based on this spectral database, and the information database are combined in one single database.

In another aspect, the instrument used for the methods of the invention further comprises a second spectral database and a second information database. This second spectral database may comprise spectra which are not present in the first spectral database and the second information database may comprise additional information about the microorganisms in the second spectral database.

The instruments for measuring and/or the databases(s) may be part of a network, such as a local, regional or global area network. The term “network”, refers to two or more computers or processing systems which are connected in such a way that messages and information may be transmitted between the computers. In such computer networks, typically one or more computers operate as a “server”, a computer with large storage devices such as hard disk drives and communication hardware to operate peripheral devices such as printers or moderns. Other computers, termed “workstations” or “clients”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. The network will comprise at least one server and at least one, and typically several workstations. Server and workstations are connected by a communication line, which may be an ethernet cable or another suitable device, such as a wireless connection. The network may also include several shared peripheral devices. In one embodiment of the invention, the spectrometer is a remote facility which is connected to the computer by a server.

A local, regional or global network of spectrometer and databases(s) may be suitably used to monitor geographical presence and changes therein of microbial strains. It may automatically issue an alert if an unusual change in geographical presence has been detected. Unusual changes include, but are not limited to the prevalence of a new strain. Such network also allows for obtaining retrospectively epidemiological data without the requirement to do additional testing. In addition, it is possible to prospectively assemble epidemiological data.

The system of the invention can further comprise a signal which is or can be made visible or audible output in one or more of the following categories:
prompting the user that the spectrum of the sample of interest is already present in the first spectral database;
prompting the user to apply other means of characterization;
prompting the user to enter information in an information database;
suggesting suitable antimicrobial therapy;
alerting the user to a change in antimicrobial agent susceptibility profile;
alerting the user of a persisting contamination;
alerting the user when an unusual change in geographical presence occurs is also part of the invention.

Although the present description is written with a focus on the classification of microorganisms from biological or environmental samples, the spectral analysis method of the present invention may also be used in other applications, such as voice recognition systems, spoken instruction recognitions systems, detection of chemical or biological compounds in complex samples, and the like.

### Example 1

The experiment exists of 1) sample preparation, 2) spotting sample and matrices, 3) measuring, and 4) data analysis

1) Sample Preparation

Harvest cells cultured on a blood agar plate (overnight at 35° C.) by transferring a small amount of bacteria into a tube containing 300 μl sterile water and mix carefully.

Add 900 μl ethanol (absolute) and mix carefully.

After 10-30 minutes incubation at room temperature, mix thoroughly and centrifuge for 5 minutes at 10 000 g and remove the supernatant with pipette.

Centrifuge 2 min. 10.000 g to remove all ethanol (one additional centrifugation step is necessary to completely remove the ethanol)

Add 50 μl 70% formic acid to the pellet and mix very well by pipetting and/or by mixing on a vortex. The pellet should be resolved as well as possible.

Add 50 μl pure acetonitrile and mix carefully.

Centrifuge for 2 minutes at 10 000 g speed

2) Spotting Sample and Matrices

Pipette 0.5 μl of supernatant per spot onto a MALDI-TOF target and allow to air dry. Prepare 8 spots for every sample.

Directly after drying: overlay 4 spots with 0.5 μl alpha-cyano-4-hydroxycinnamic acid (HCCA, Bruker Daltonics, Bremen, Germany) HCCA matrix solution and overlay 4 spots with 0.5 μl FA+ (12.5 mg/ml ferulic acid in a mix of formic acid/acetronitrile (AN)/water) matrix.

Allow to air dry.

3) Measuring
Generate MS-spectra from spots covered with HCCA measuring in the reflectron mode (mass range 800-4000 Da)

Calibrate with: peptide calibration standard (Bruker):

Settings of the used MALDI-TOF MS.

Laser energy: 30%

Laser rep. rate: 200 Hz

ion source voltage 1: 19 kV

ion source voltage 2: 16.6 kV

PIE delay: 0 ns

reflectron voltage 1: 21 kV

reflectron voltage 2: 9.55 kV

reflectron detector voltage: 1.704 kV

number of shots: 2000

deflection mass: 400

sample rate 1 Gs/s
Generate MS-spectra from spots covered with HCCA measuring in the linear mode (mass range 800-20.000 Da, Bruker protocol):

Calibrate with: Bacterial test standard (Bruker):

Settings of the used MALDI-TOF MS.

Laser energy: 40%

Laser rep. rate: 200 Hz

ion source voltage 1: 20 kV

ion source voltage 2: 18.75 kV

PIE delay: 350 ns

linear detector voltage: 1.522 kV

number of shots: 2000

gating: 800

sample rate 2 Gs/s
Generate MS-spectra from spots covered with FA+ measuring in the linear mode (mass range 4000-80.000 Da), high laser energy:

Calibrate with: protein standard II (Bruker):

Settings of the used MALDI-TOF MS.

Laser energy: 80%

Laser rep. rate: 100 Hz

ion source voltage 1: 20 kV

ion source voltage 2: 18.75 kV

PIE delay: 350 ns

linear detector voltage: 1.522 kV

number of shots: 2000

gating: 4000

sample rate 2 Gs/s

4) Data Analysis

Using MATLAB software (Mathworks, Natick, Mass., U.S.A.) the four MS-spectra per measurement (HCCA in reflectron mode, HCCA in linear mode, and FA+ in linear mode) are pre-processed in a 5-step approach: (1) mass adjustment, (2) smoothing, (3) baseline subtraction, (4) normalization, and (5) peak detection. Next by taking the mean of the four MS-spectra per measurement—one spectrum is generated. Subsequently, the obtained three spectra are combined in one ‘extended spectrum’ by combining the peak list of the three measurements. This is preferable be done automatically but can also be performed manually by visual checking similar peaks.

Next, the extended spectrum can be compared with another extended spectrum, e.g. derivable from a reference library.

1. A method for classification of spectral data comprising:
a. obtaining at least two spectrograms of different mass range of a sample by performing at least two different mass spectrography measurements, each with a different matrix;
b. adding the at least two spectrograms;
c. comparing the sample spectrogram resulting from step b) with one or more spectrograms of known samples;
d. if there is no difference between the sample spectrogram and a spectrogram of a known sample, declaring the sample identical to the known sample.

2. Method according to claim 1, wherein the matrices are selected from the group of matrices listed in Table 1.

3. Method according to claim 1, wherein the sample comprises a micro-organism, preferably a bacterium, a virus or a fungus.

4. Method according to claim 1, wherein the spectrogram is a MALDI-TOF spectrogram.

5. Method according to claim 1, wherein the two or more spectrograms are partially overlapping.

6. Use of a spectrogram which is composed of at least two spectrograms obtained by analysing a sample in a mass spectrometer with at least two different matrices, for the classification of spectral data, particularly spectral data of micro-organisms.

7. A method for classification of micro-organisms comprising:
a. obtaining at least two spectrograms of different mass range of a sample of said micro-organism by performing at least two different mass spectrography measurements, each with a different matrix;
b. adding the at least two spectrograms obtained in step a);
c. comparing the resulting spectrogram resulting from step b) with one or more spectrograms of samples of known micro-organisms;
d. if there is no difference between the spectrogram obtained in step b) and a spectrogram of a known micro-organism, declaring the micro-organism to be classified identical to the known micro-organism.

8. Method according to claim 7, wherein the known micro-organism is a particular strain of a micro-organism species of which the spectrogram differs from the spectrogram of a different strain of the same micro-organism species.
